(19) United States
(12) Patent Application Publication
(10) Pub. No.: US 2008/0235259 A1
(43) Pub. Date: Sep. 25, 2008

(54) Fine Grained Jump-Points in Digital Metadata

(76) Inventors: Michael N. Abernethy, Jr., Pflugerville, TX (US); Travis M. Grigsby, Austin, TX (US); Syed-Muasir Khalil, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/690,478

(22) Filed: Mar. 23, 2007

(51) Int. Cl. G06F 17/00

(52) U.S. Cl. 707/102; 707/E17.005

(57) ABSTRACT

A method, computer program product, and system are provided for accessing media content. A media device outputs first content that includes an indicator to an output device. The media device determines if related second content exists for the first content based on the indicator. Responsive to the existence of the related second content, the media device prompts a user for command to access the related second content. Then, responsive to receiving the first command from the user, the media device pauses the output of the first content and initiates output of the related second content to the output device.

### BACKGROUND

1. Technical Field

The present application relates to metadata embedded within media. More particularly, the present application provides a method, system, and computer program product for accessing media content using metadata embedded within the media.

2. Description of Related Art

Many media programs have a chronological order. That is, events within an airing of one media program may reference events that occur within other airings of the media program. Additionally, media programs may contain events that build off of other events and watching the media programs out of order may negatively impact the experience of watching the media program. Additionally, while viewing a media program, a user may question “Who's that?” or “How did that guy get that gun?” If the user does not know the correct order to watch the media programs or where certain events occurred, the user may lose some of the perceived value of the media program.

Currently, some users may record these media programs on digital video recorders (DVR) or personal video recorders (PVR), which are devices that record video and audio media without videotape to a hard drive-based digital storage medium. While these users may have access to the recorded airings of the media program, currently there is no easy way for the users to find the correct airing or find the particular segment within an airing that references the events.

### SUMMARY

As media broadcasters broadcast in digital format, the broadcasters have access to create increasing amounts of descriptive metadata information during the production process. Such metadata could be augmented with higher-order descriptors, e.g., details about actions, topics, or events. These descriptors could be produced automatically via ex-post-facto analysis of the aural and visual contents in the media. Likewise, media that was originally produced with little metadata beyond a title and producer could be automatically analyzed to fill out additional metadata fields to better support subsequent information retrieval from media archives.

Thus, there needs to be a way for users who have access to media programs to access important events in the media programs, from something as fleeting as a small scene which is important, all the way up to a series that the user should watch prior to watching the media content.

The illustrative embodiments provide a method, computer program product, and system for accessing media content. The illustrative embodiments output first content that includes an indicator to an output device, determine if related second content exists for the first content based on the indicator, prompt a user for a command to access the related second content in response to the existence of related second content, pause the output of the first content, and initiate the output of the related second content to the output device in response to receiving the first command from the user.

In pausing the output of the first content, other illustrative embodiments store the first content. Storing the first content allows for the first content to be resumed from the point of pause once output of the related second content ends. Yet another illustrative embodiment receives a second command from the user to stop output of the related second content and resuming output of the first content in response to receiving the second command from the user.

In determining if related second content exists for the first content, another illustrative embodiment analyzes metadata associated with the first content for a set of metadata tags, store the set of metadata tags in a storage, analyze the at least one indicator for a referencing metadata tag, and match the referencing metadata tag to at least one of the set of metadata tags. The set of metadata tags references at least one segment of the related second content.

In prompting the user for the command to access the related second content, the illustrative embodiments output to at least one of a pop-up, a banner, a picture-in-picture, a split screen, or an audio indication concurrently with the first content on the output device.

Other illustrative embodiments locate the related second content on at least one of a local storage or a remote server. In locating the related second content on the remote server, the illustrative embodiments determine if the related second content exists on the remote server, determine if the user has indicated a preference to access the related second content from the remote server in response to the existence of the related second content on the remote server, initiate output of the related second content from the remote server to the output device responsive to the existence of an indication from the user. Responsive to the absence of the indication from the user, the illustrative embodiments prompt the user for a second command to access the related second content from the remote server, and initiate output of the related second content from the remote server to the output device responsive to receiving the second command from the user.

In other illustrative embodiments, a computer program product comprising a computer useable medium having a computer readable program is provided. The computer readable program, when executed on a computing device, causes the computing device to perform various ones, and combinations of, the operations outlined above with regard to the method illustrative embodiment.

In yet another illustrative embodiment, a system is provided. The system may comprise a processor and a memory coupled to the processor. The memory may comprise instructions which, when executed by the processor, cause the processor to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 shows a block diagram of a data processing system in which the illustrative embodiments may be implemented;

FIG. 2 depicts a pictorial representation of a network of data processing systems in which the illustrative embodiments may be implemented;

FIG. 3 depicts a functional block diagram of a media device in accordance with an illustrative embodiment;

FIG. 4 depicts exemplary content metadata in accordance with an illustrative embodiment;

FIG. 5 depicts an exemplary event notification in accordance with an illustrative embodiment;

FIG. 6 depicts a flow diagram of the operation performed by a media device in detecting metadata in accordance with an illustrative embodiment;

FIG. 7 depicts a flow diagram of the operation performed by a media device in detecting jump-point indicators in accordance with an illustrative embodiment; and

FIG. 8 depicts a flow diagram of the operation performed by a media device in accessing media content using metadata embedded within the media in accordance with an illustrative embodiment.

### DETAILED DESCRIPTION OF THE ILLUSTRATIVE EMBODIMENTS

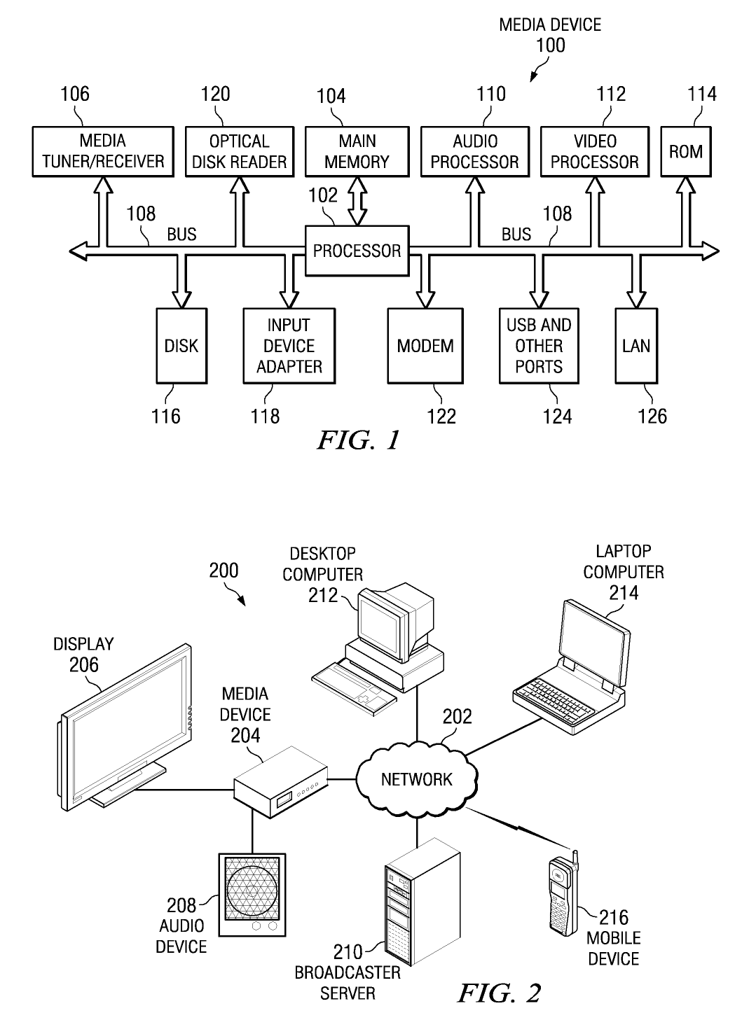

The illustrative embodiments provide mechanisms for accessing media content using metadata embedded within the media. The illustrative embodiments use the term media for content that is broadcast though the distribution of audio and/or video signals to a user. With the illustrative embodiments, a data processing device used to access media content may be a single-processor computing device, a multiprocessing data processing system, or a virtual processor environment in which multiple processors and multiple layers of software may be utilized to perform various aspects of the illustrative embodiments. Therefore, FIGS. 1 and 2 are provided as exemplary diagrams of data processing environments in which the illustrative embodiments may be implemented. It should be appreciated that FIGS. 1 and 2 are only exemplary and are not intended to assert or imply any limitation with regard to the environments in which the illustrative embodiments may be implemented. Many modifications to the depicted environments may be made without departing from the spirit and scope of the present application.

With reference now to FIG. 1, a block diagram of a data processing system is shown in which the illustrative embodiments may be implemented. Media device 100 is an example of a media device, for example, a digital video recorder (DVR), personal video recorders (PVR), cable television receiver, satellite television receiver, or the like, in which code or instructions implementing the processes of the illustrative embodiments may be located. However, media device 100 may also be a computer that is capable of recording and outputting media from broadcasters who provide online media. In the depicted example, media device 100 employs a bus architecture through which processor 102 connects to other components of the device. Main memory 104 is connected to processor 102.

Media tuner/receiver 106 is connected to processor 102 through bus 108. Media tuner/receiver 106 may be, for example, a National Television System Committee (NTSC), Advanced Television Systems Committee (ATSC) over the air (OTA) tuner. Alternatively, media tuner/receiver 106 may be a digital cable or digital satellite receiver. In yet another embodiment, media tuner/receiver 106 may be a media input port that receives an audio/video signal from an external tuner/receiver. Other receivers may also be used in place of media tuner/receiver 106, such as a satellite radio receiver, for example.

Bus 108 also connects audio processor 110, video processor 112, read-only memory (ROM) 114, disk 116, and input device adapter 118 to processor 102. Audio processor 110 may provide audio processing, such as Dolby® Pro Logic® II or Dolby Digital surround sound decoding. Video processor 112 may perform processing, such as MPEG2 or MPEG4 decoding. Disk 116 may be a hard disk drive (HDD) for storing media content streams. Input device adapter 118 may be, for example, an infrared (IR) remote control receiver, a keyboard/mouse adapter, or the like.

Media device 100 may also include optical disk reader 120, which may be, for example, a compact disk (CD) drive, digital video disk (DVD) drive, or the like. Modem 122 may be used to dial into a server to access the Internet, retrieve program guide information, or the like. Universal Serial Bus (USB) and other ports 124 may be connected to processor 102 through bus 108. These ports may allow peripheral devices, such as printers, network adapters, etc., to be connected to media device 100. Local area network adapter (LAN) 126 may allow media device 100 to connect to the Internet, share media content to other devices, or to acquire program guide data.

An operating system runs on processor 102 and is used to coordinate and provide control of various components within media device 100 in FIG. 1. The operating system may be a commercially available operating system such as Linux™. “LINUX” is a trademark of Linus Torvalds. Instructions for the operating system and applications or programs are located on storage devices, such as hard disk drive 116 or ROM 114, and may be loaded into main memory 104 for execution by processor 102. The processes of the illustrative embodiments may be performed by processor 102 using computer implemented instructions, which may be located in a memory such as, for example, main memory 104.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. The depicted example in FIG. 1 and above-described examples are not meant to imply architectural limitations. For example, media device 100 also may be a desktop computer, laptop computer, or telephone device in addition to taking the form of a media device.

Media device 100 may store media content on disk 116. In accordance with an illustrative embodiment, media device 100 provides a means to enable the user of media device 100 to be able to access media as current media content, identify related media content using metadata associated with the current media content, pause the current media content, access the related media content, and then resume access of the current media content.

FIG. 2 depicts a pictorial representation of a network of data processing systems in which the illustrative embodiments may be implemented. Network data processing system 200 is a network of computers in which the present invention may be implemented. Network data processing system 200 contains network 202, which is the medium used to provide communications links between various devices and computers connected together within network data processing system 200. Network 202 may include connections, such as a wired link, wireless communication links, fiber optic cables, or satellite link.

In the depicted example, media device 204, such as media device 100 of FIG. 1, is connected to network 202 and is also connected to an output device, such as display 206, audio device 208, or the like. Additionally, broadcaster server 210 may also act as a media device and is connected to network 202. In addition, desktop computer 212, laptop computer 214, and mobile device 216 may be connected to network 202. Desktop computer 212, laptop computer 214, or mobile device 216 may have access to media device 204 and broadcaster server 210 through network 202. For example, a user may be accessing a previously recorded media content that is stored on media device 204 or online media content that is stored on broadcaster server 210 via desktop computer 212, laptop computer 214, or mobile device 216 via network 202.

The media may include metadata that is digitally embedded in the media content. When media device 204 receives the media, related media content information may be presented to the user on an output device, for example, display 206, audio device 208, desktop computer 212, laptop computer 214, mobile device 216, or the like, based on the metadata in the media content information. When a user sees the related media content information, the user may choose to access the related media content that is stored on media device 204 through network 202.

Network data processing system 200 may include additional servers, clients, and other devices not shown. In the depicted example, network data processing system 200 is embodied within the Internet. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

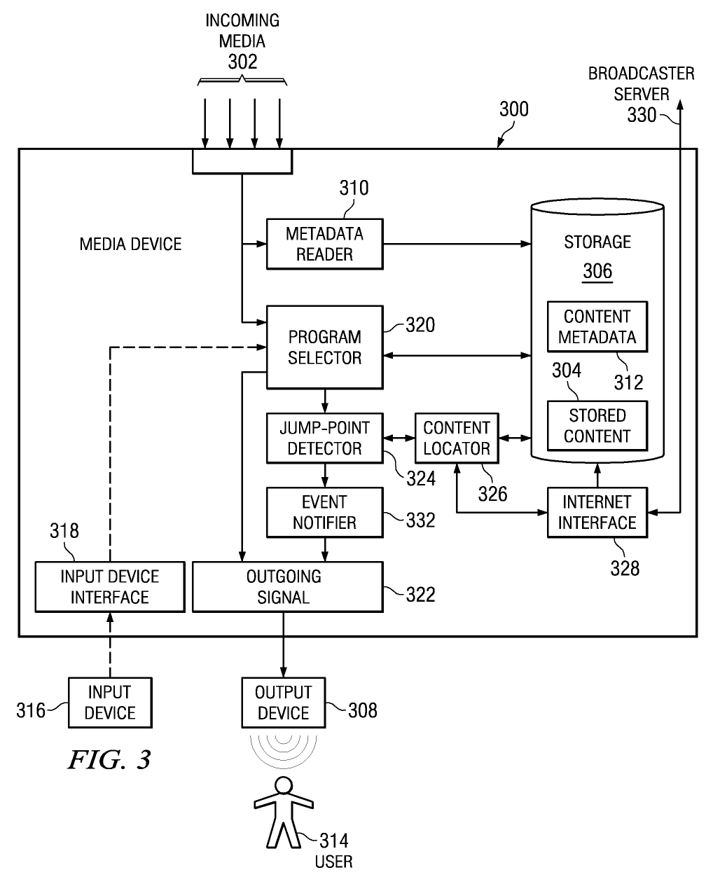

FIG. 3 depicts a functional block diagram of a media device in accordance with an illustrative embodiment. Media device 300 may be a media device, such as media device 204 of FIG. 2. Media device 300 receives incoming media 302 that is broadcast media from a network provider over communication connections, such as a wired link, wireless communication links, fiber optic cables, or a satellite link. It should be appreciated that the various communication connections are only exemplary and are not intended to assert or imply any limitation with regard to the communication connections the illustrative embodiments may use.

Media device 300 may be set up to store incoming media 302 as stored content 304 in storage 306 or present incoming media 302 as real-time content. Both stored content 304 and real-time content are output to output device 308. Both stored and real-time content may be a program that is a segment of broadcast programming, for example, a television program or a radio program. A program may be a single broadcast or part of a periodically broadcast series. A broadcast series that is intended to air a finite number of smaller segments is usually called a miniseries or serial. A series that is intended over many years or seasons usually consists of 6-26 smaller installments. A single instance or installment of a program may be referred to as an episode, while a one-time program may be referred to as a special.

Whether incoming media 302 is stored or real-time, media device 300 includes metadata reader 310 that analyzes incoming media 302 to determine if incoming media 302 includes embedded metadata tags. If metadata reader 310 detects an embedded metadata tag, metadata reader 310 stores, for a factory defined amount of time or a user-specified amount of time, the metadata tag as content metadata 312 in storage 306. Content metadata 312 may be stored, for example, in a table format, linked list, etc. Additionally, metadata tags may be received after the initial broadcast of the media or existing metadata tags may be replaced during the reception of a subsequent reception of the media. That is, if a program replays or airs at a later time and the broadcaster has embedded new metadata tags or changes the previously stored metadata tags, then the updated or new metadata tags would be stored using the previously described process. Additionally, the metadata tags may refer to a future event, thus, in addition to the metadata tag being used for referencing related content, then the metadata tag may also be used to automatically program the recording of the future program.

User 314 may indicate stored or real-time content to be accessed using input device 316. Input device interface 318 receives the media selection from input device 316 and transmits the media selection to program selector 320. Program selector 320 uses the user's media selection to transmit the stored or real-time content through outgoing signal 322 to output device 308. During transmission of the content, jump-point detector 324 determines if embedded metadata within the content includes a jump-point indicator. A jump-point indicator indicates a point within the content that refers to other related content, for example, a current, past, or future installment, or segment within a current, past, or future installment. The jump-point indicator includes a metadata tag that includes a program identifier, an installment identifier, and metadata description. Related content may also be referred to as a related event, since the related content is stored or real-time content. If jump-point detector 324 encounters a jump-point indicator, jump-point detector 324 sends jump-point metadata to content locator 326. Content locator 326 uses the jump-point metadata to determine if the related content referred to in the jump-point indicator is available.

In order to determine if the related content is available, content locator 326 analyzes stored content 304 using the metadata from the jump-point indicator to see if the related content is stored locally. Also, since broadcasters are making media content available on the broadcasters' Websites, content locator 326 may use Internet interface 328 to determine if the related content is available from the broadcaster on broadcaster server 330 if the related content is not stored locally.

Prior to downloading the content from the broadcaster's Website, content locator 326 may identify if the user has indicated a preference to download all related content without prompting. However, if content locator 326 can not locate a user preference on downloading related content or in the event a charge exists for downloading the related content, then content locator 326 may prompt the user for the desire to download the requested content using event notifier 332.

If content locator 326 is able to locate the related content, then jump-point detector 324 may send a signal to event notifier 332, so that event notifier 332 notifies the user that the current content being output is related to other content. If content locator 326 does not locate the related content, then no notification is output to output device 308.

In order for the event notification and the current content to coincide properly on output device 308, the media producer may insert jump-point indicators earlier within the content, so that content locator 326 has the necessary time to determine if the related content may be located. Then, the producer may insert an event indicator at the time of the event so that the event notification and the current content coincide if the content locator 326 locates the related content.

Event notifier 332 may send a notification via outgoing signal 322 to output device 308, for example, as a pop-up that is concurrently output with the current content. Other examples of presenting the event notification may be to present the event notification as a banner, a picture-in-picture, a split screen, an audio signal, or the like. Event notifier 332 continues to output the notification concurrently with the current content until the segment associated with the event changes, which may be indicated through, for example, an end of a scene marker, another jump-point indicator, other metadata indicator, a black screen which may be use to show a break in programming, or the like. If the user indicates a desire to access the related content during the time period that the event notifier 332 is outputting the notification, then program selector 320 detects the indication via input device interface 318. Program selector 320 may then pause the current content to output the related content as a related content. In pausing the current content, program selector 320 may either immediately start long-term recording of the current content or use a short-term delay feature, as is commonly available in media devices.

Program selector 320 may then output the related content through outgoing signal 322 to output device 308. The output may be in the form of a full screen display, a split screen display, a pop-up display or the like. The output of the related content is controlled by the user, in that the user may fast forward, reverse, skip, stop, or the like. While outputting the related content, if program selector 320 receives a command from the user via input device 316, that the user desires to end access of the related content, then program selector 320 stops transmitting the related content and resumes transmitting the current content in a delayed format. If the user accesses the related content in its entirety, then program selector 320 resumes transmitting the current content in a delayed format. If the output of the related content is in the form of a split screen display or a pop-up display, then the window in which the related content was created automatically closes upon completion of the output of the related content. Additionally, as the related content is being output, the related content may also have embedded metadata tags, these related content metadata tags are handled in the same manner as described above.

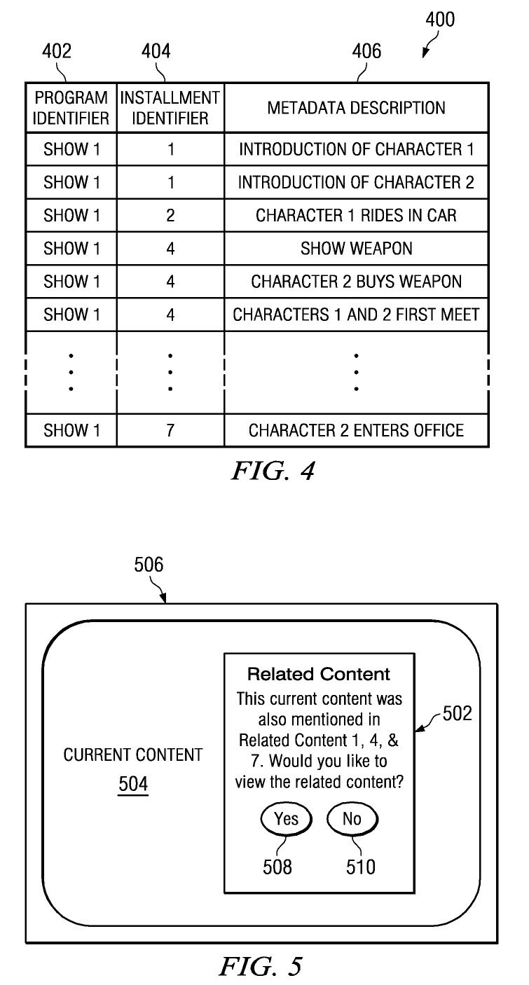

FIG. 4 depicts exemplary content metadata in accordance with an illustrative embodiment. Content metadata table 400 stores content metadata, such as content metadata 312 of FIG. 3, which may include program identifier 402, installment identifier 404, and metadata description 406. For each metadata tag, content metadata table 400 stores program identifier 402, installment identifier 404, and metadata description 406. Program identifier 402 may be, for example, the name or identifier of the program, just a portion of the name of the program, a numerical identifier for the program, or the like. Installment identifier 404 may include, for example, an installment code or identifier, a name of the installment, a year the installment first aired, or the like.

Metadata description 406 may include a description associated with the metadata tag, such as “introduction of character 1”, “introduction of character 2”, “characters 1 and 2 first meet”, or the like. It should be appreciated that the content metadata are only exemplary and are not intended to assert or imply any limitation with regard to the content metadata the illustrative embodiments may use. Content metadata table 400 may be used by a content locator to determine if related content referred to in the jump-point indicator is available when a jump-point detector encounters the jump-point indicator.

FIG. 5 depicts an exemplary event notification in accordance with an illustrative embodiment. Event notification 502 may be presented, for example, as a pop-up on top of current content 504 which is output on output device 506, such as output device 308 of FIG. 3. Other examples of presenting event notification 502 may be to present event notification 502 as a banner, a picture-in-picture, a split screen, an audio signal, or the like. Event notification 502 may indicate to the user that the current event was previously mentioned in related content and prompt the user if the user would like to access the related content. The user may select to access the related content by selecting “Yes” button 508 or deny access to the related content by selecting “No” button 510 using the input device. If the user indicates a desire to access the related content, then a program selector may then pause the current content to output the related content. If the user fails to indicate a desire to access the related content, then the current content continues to be output to the output device.

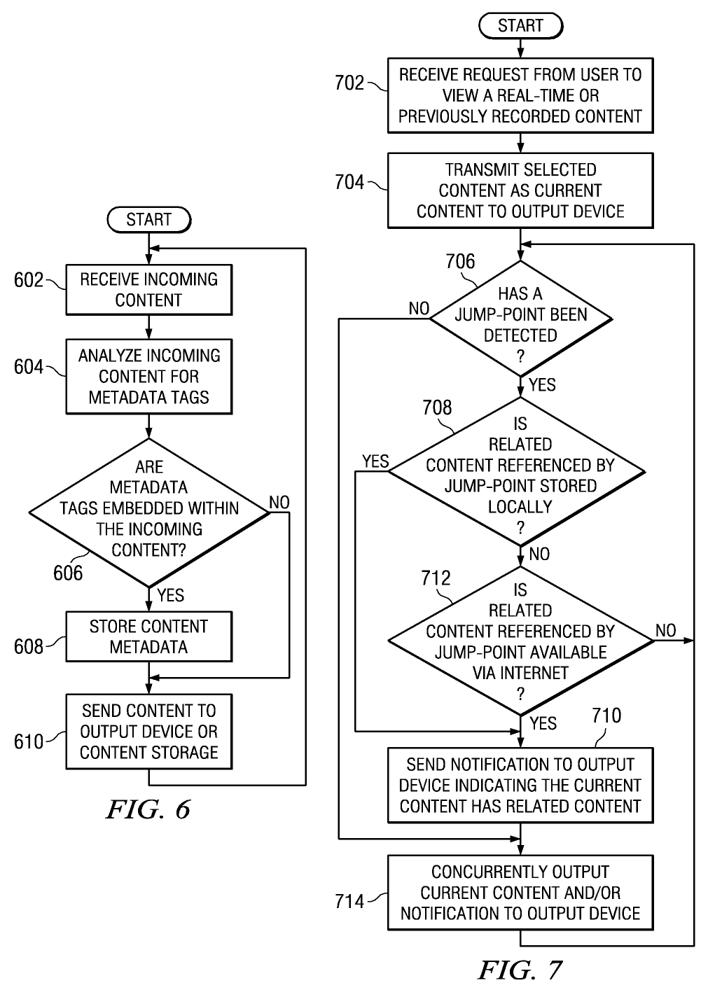

FIG. 6 depicts a flow diagram of the operation performed by a media device in detecting metadata in accordance with an illustrative embodiment. The operation described in FIG. 6 is performed by a media device such as media device 300 of FIG. 3. As the operation begins, a media device receives incoming content from a network provider over a communication connection, such as a wired link, wireless communication links, fiber optic cables, a satellite link, or the like (step 602). A metadata reader, such as metadata reader 310 of FIG. 3, analyzes the incoming content for embedded metadata tags (step 604). If the metadata reader detects an embedded metadata tag (step 606), metadata reader stores information associated with the metadata tag as content metadata in a storage device (step 608). The content is then sent to the output device or to content storage as identified by the user (step 610), with the operation returning to step 602. Returning to step 606, if metadata reader does not detect any metadata tags, then the content is sent to the output device or to content storage as identified by the user (step 610), with the operation returning to step 602.

FIG. 7 depicts a flow diagram of the operation performed by a media device in detecting jump-point indicators in accordance with an illustrative embodiment. The operation described in FIG. 7 may be performed by a media device such as media device 300 of FIG. 3. As the operation begins, a program selector, such as program selector 320 of FIG. 3, receives a request from the user to access real-time or previously recorded content (step 702). The program selector outputs the desired content as current content to the output device (step 704).

During the output of the current content, a jump-point detector, such as jump-point detector 324 of FIG. 3, determines if embedded metadata that may be included within the current content includes a jump-point indicator (step 706). A jump-point indicator indicates a point within the current content that refers to a related content. If jump-point detector detects a jump-point indicator, a content locator attempts to locate the related content on a local storage (step 708). If at step 708, the content locator is able to locate the related content locally, an event notifier sends a notification to the output device that the content currently being output was previously mentioned in related content (step 710).

If at step 708, the event locator is unable to locate the related content, then the event locator attempts to locate the related content on a broadcaster's server (step 712). If at step 712, the event locator is able to locate the related content on the broadcaster's server, the event notifier outputs a notification to the output device that the segment being output was previously mentioned in related content (step 710). If at step 712, the event locator is unable to locate the related content, the operation returns to step 706 to wait for the next jump-point indicator. After the event notifier outputs a notification to the output device, the media device continues to output the notification concurrently with the current content until the segment associated with the event changes (step 714), with the operation returning to step 706 thereafter.

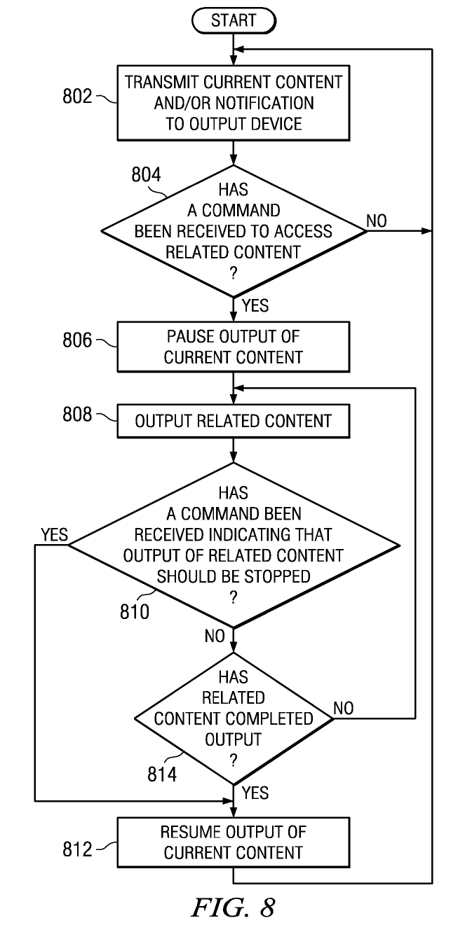

FIG. 8 depicts a flow diagram of the operation performed by a media device in accessing media content using metadata embedded within the media in accordance with an illustrative embodiment. The operation described in FIG. 8 is performed by a media device such as media device 300 of FIG. 3. As the operation begins, an event notifier outputs a notification concurrently with the current content until the segment associated with the event changes (step 802). A program selector monitors the input device interface to determine if the user indicates a command to access the related content (step 804). If at step 804 the user fails to indicate a command to access the related content, the operation returns to step 802. If at step 804 the user indicates a command to access the related content, the program selector pauses the output of the current content (step 806).

The program selector then initiates the output of the related content to the user's output device (step 808). While outputting the related content, the program selector monitors the input device interface to determine if the user desires to end output of the related content (step 810). If at step 810 the user indicates a desire to stop output of the related content, the program selector resumes output of the current content in a delayed format (step 812), with the operation returning to step 802. If at step 810 fails to indicate a desire to stop output of the related content, the program selector determines if the related content has been output in its entirety (step 814). If at step 814 the related content has not completed playing, then the operation returns to step 808. If at step 814 the related content is played in its entirety, then the program selector resumes output of the current content in a delayed format (step 812), with the operation returning to step 802.

Thus, the illustrative embodiments provide for accessing media content using metadata embedded within the media. The illustrative embodiments output first content that includes an indicator to an output device, determine if related second content exists for the first content based on the indicator, prompt a user for a command to access the related second content in response to the existence of related second content, and pause the output of the first content and initiate the output of the related second content to the output device in response to receiving the first command from the user.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for accessing media content, the computer implemented method comprising:
outputting a first content to an output device, wherein the first content includes at least one indicator;
determining if related second content exists for the first content based on the at least one indicator;
responsive to the existence of the related second content, prompting a user for a first command to access the related second content; and
responsive to receiving the first command from the user, pausing the output of the first content and initiating output of the related second content to the output device.

2. The method of claim 1, wherein pausing the output of the first content further comprises:
storing the first content, wherein storing the first content allows for the first content to be resumed from the point of pause once output of the related second content ends.

3. The method of claim 1, further comprising:
receiving a second command from the user to stop output of the related second content; and
responsive to receiving the second command from the user, stopping output of the related second content and resuming output of the first content.

4. The method of claim 1, wherein determining if the related second content exists for the first content further comprises:
analyzing metadata associated with the first content for a set of metadata tags, wherein the set of metadata tags references at least one segment of the related second content;
storing the set of metadata tags in a storage;
analyzing the at least one indicator for a referencing metadata tag; and
matching the referencing metadata tag to at least one of the set of metadata tags.

5. The method of claim 1, wherein prompting the user for the command to access the related second content further comprises:
outputting at least one of a pop-up, a banner, a picture-in-picture, a split screen, or an audio indication concurrently with the first content on the output device.

6. The method of claim 1, further comprising:
locating the related second content on at least one of a local storage or a remote server.

7. The method of claim 6, wherein locating the related second content on the remote server further comprises:
determining if the related second content exists on the remote server;
responsive to the existence of the related second content on the remote server;
determining if the user has indicated a preference to access the related second content from the remote server; and
responsive to the existence of an indication from the user, initiating output of the related second content from the remote server to the output device.

8. The method of claim 7, further comprising:
responsive to the absence of the indication from the user, prompting the user for a second command to access the related second content from the remote server; and
responsive to receiving the second command from the user, initiating output of the related second content from the remote server to the output device.

9. A computer program product comprising a computer useable medium having a computer readable program, wherein the computer readable program, when executed in a data processing system, causes the data processing system to:
output a first content to an output device, wherein the first content includes at least one indicator;
determine if related second content exists for the first content based on the at least one indicator;
responsive to the existence of the related second content, prompt a user for a first command to access the related second content; and
responsive to receiving the first command from the user, pause the output of the first content and initiate output of the related second content to the output device.

10. The computer program product of claim 9, wherein the computer readable program to pause the output of the first content further causes the data processing system to:
store the first content, wherein storing the first content allows for the first content to be resumed from the point of pause once output of the related second content ends.

11. The computer program product of claim 9, wherein the computer readable program further causes the data processing system to:
receive a second command from the user to stop output of the related second content; and
responsive to receiving the second command from the user, stop output of the related second content and resuming output of the first content.

12. The computer program product of claim 9, wherein the computer readable program to determine if the related second content exists for the first content further include computer readable program that causes the data processing system to:
analyze metadata associated with the first content for a set of metadata tags, wherein the set of metadata tags references at least one segment of the related second content;
store the set of metadata tags in a storage;
analyze the at least one indicator for a referencing metadata tag; and
match the referencing metadata tag to at least one of the set of metadata tags.

13. The computer program product of claim 9, wherein the computer readable program to prompt the user for the command to access the related second content further include computer readable program that causes the data processing system to:
output at least one of a pop-up, a banner, a picture-in-picture, a split screen, or an audio indication concurrently with the first content on the output device.

14. The computer program product of claim 9, wherein the computer readable program further causes the data processing system to:
locate the related second content on at least one of a local storage or a remote server.

15. A system, comprising:
a processor; and
a memory coupled to the processor, wherein the memory comprises instructions which, when executed by the processor, cause the processor to:
output a first content to an output device, wherein the first content includes at least one indicator;
determine if related second content exists for the first content based on the at least one indicator;
responsive to the existence of the related second content, prompt a user for a first command to access the related second content; and
responsive to receiving the first command from the user, pause the output of the first content and initiate output of the related second content to the output device.

16. The system of claim 15, wherein the instructions to pause the output of the first content further cause the processor to:
store the first content, wherein storing the first content allows for the first content to be resumed from the point of pause once output of the related second content ends.

17. The system of claim 15, wherein the instructions further cause the processor to:
receive a second command from the user to stop output of the related second content; and
responsive to receiving the second command from the user, stop output of the related second content and resuming output of the first content.

18. The system of claim 15, wherein the instructions to determine if the related second content exists for the first content further include instructions that cause the processor to:
analyze metadata associated with the first content for a set of metadata tags, wherein the set of metadata tags references at least one segment of the related second content;
store the set of metadata tags in a storage;
analyze the at least one indicator for a referencing metadata tag; and
match the referencing metadata tag to at least one of the set of metadata tags.

19. The system of claim 15, wherein the instructions to prompt the user for the command to access the related second content further include instructions that cause the processor to:
output at least one of a pop-up, a banner, a picture-in-picture, a split screen, or an audio indication concurrently with the first content on the output device.

20. The system of claim 15, wherein the instructions further cause the processor to:
locate the related second content on at least one of a local storage or a remote server.
